(19) United States
(12) Patent Application Publication
(10) Pub. No.: US 2017/0083121 A1
(43) Pub. Date: Mar. 23, 2017

(54) PEN AND ELECTRONIC DEVICE INCLUDING THE SAME

(71) Applicant: Samsung Electronics Co., Ltd., Gyeonggi-do (KR)

(72) Inventors: Tae-Hwan KANG, Gyeongsangbuk-do (KR); Jongyoon LIM, Busan (KR)

(21) Appl. No.: 15/269,452

(22) Filed: Sep. 19, 2016

(30) Foreign Application Priority Data
Sep. 17, 2015 (KR) 10-2015-0131627

(51) Int. Cl. G06F 3/0354

(52) U.S. Cl. CPC G06F 3/03545

(57) ABSTRACT

Disclosed is an electronic device that enables the waterproofing of an input pen that is removably mounted on the electronic device.

### PRIORITY

This application claims priority under 35 U.S.C. §119(a) to a Korean Patent Application which was filed in the Korean Intellectual Property Office on Sep. 17, 2015 and assigned Serial No. 10-2015-0131627, the contents of which are incorporated herein by reference.

### BACKGROUND

1. Field of the Disclosure

The present disclosure relates generally to a pen and electronic device, and more particularly, to a pen that is removably mounted on an electronic device and an electronic device including the same.

2. Description of the Related Art

An input pen is frequently used in order to input necessary information to a touch screen of an electronic device. Such pen types include a pressure-sensitive input pen that applies a predetermined pressure to be recognized by the touch screen and a capacitive input pen.

Input pens to be used for a touch screen have generally been adopted as an internal type to be detachably mounted on an electronic device. Recently, in order to reduce the size, thickness, and weight of an electronic device, input pens have also been adopted as an external type to be held separately from the electronic device.

The input pens configured to be detachably mounted on an electronic device are conveniently portable and involve less risk of being misplaced. However, because the input pens may be used anytime and anywhere, there is an increased risk of the pens incurring water infiltration, thereby causing damage to the pens.

As such, there is a need in the art for an input pen that is impervious to such water infiltration.

### SUMMARY

The present disclosure has been made to address the above-mentioned problems and disadvantages, and to provide at least the advantages described below.

Accordingly, an aspect of the present disclosure is to provide an electronic device that enables the waterproofing of an input pen mounted on the electronic device.

According to an aspect of the present disclosure, an electronic device may include a housing that includes a first face that is directed to a first direction, a second face that is directed opposite to the first direction, and a side face that at least partially encloses a space between the first face and the second face, an opening that is formed in the side face of the housing; a hole connected to the opening, a contact disposed inside the hole; a stylus pen configured to be at least partially inserted into the hole, and to be removable from the hole, a friction member arranged on at least a portion of an outer surface of the stylus pen, and formed to be in contact with an inner portion of the hole, a display module exposed to the first face of the housing, and configured to receive an input through the stylus pen, a processor electrically connected to the display module, and a memory electrically connected to the processor.

According to another aspect of the present disclosure, an electronic device may include a case, an input pen inserted into and removable from the case, and at least one sealing member mounted on an outer surface of the input pen such that at least a portion of the sealing member protrudes outward, and when the input pen is mounted in the case, at least a portion of the input pen may be in close contact with an inner surface of the case so as to seal an inner portion of the case.

According to another aspect of the present disclosure, an electronic device may include a rear case, an input pen insertion section formed in the rear case, one or more sealing members arranged on a first face of the insertion section along a direction of mounting and removing the input pen such that the sealing members partially protrude from the first face of the insertion section, wherein, when the input pen is inserted, the sealing member may fix the inserted input pen while sealing an inner portion of the insertion section by being in close contact with the input pen.

According to another aspect of the present disclosure, an electronic device may include a rear case a back cover coupled to the rear case, an input pen insertion section arranged along a side of the rear case, an input pen configured to be mounted in and removed from the input pen insertion section, at least one sealing member mounted on an outer surface of the input pen, and configured to primarily fix the input pen while sealing an inner portion of the case by being at least partially in close contact with an inner surface of the case, and a damper disposed in the input pen insertion section to secondarily fix the input pen inserted into the input pen insertion section.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates the front face of an electronic device according to embodiments of the present disclosure;

FIG. 2 illustrates the rear face of the electronic device according to embodiments of the present disclosure;

FIG. 3 illustrates an electronic device including an input pen waterproof device according to embodiments of the present disclosure;

FIG. 4 illustrates an exterior of an input pen, which is mounted with a sealing member, according to embodiments of the present disclosure;

FIG. 5 illustrates when an input pen according to embodiments of the present disclosure is mounted in an insertion section;

FIG. 6 illustrates the mounted state of a sealing member when an input pen according to embodiments of the present disclosure is mounted in an insertion section;

FIG. 7 illustrates the mounted state of the sealing member according to embodiments of the present disclosure;

FIG. 8 illustrates when an input pen according to embodiments of the present disclosure is mounted in an insertion section and an end of the input pen is coupled to a damper;

FIG. 9 illustrates when a sealing member according to embodiments of the present disclosure is mounted on the inner surface of the insertion section;

FIGS. 10A, 10B, 10C, 10D, 10E, 10F and 10G are sectional views each illustrating an input pen that is mounted with a sealing member according to embodiments of the present disclosure;

FIGS. 11A, 11B, 11C and 11D illustrate various shapes of a sealing member mounted on an input pen according to embodiments of the present disclosure, respectively;

FIGS. 12A, 12B, 12C and 12D illustrate various shapes of a sealing member mounted in an insertion section according to embodiments of the present disclosure, respectively; and

FIG. 13 is a block diagram of an electronic device according to embodiments of the present disclosure.

### DETAILED DESCRIPTION OF EMBODIMENTS OF THE DISCLOSURE

Embodiments of the present disclosure will now be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expressions “have”, “may have”, “include”, or “may include” refer to the existence of a corresponding feature, such as numeral, function, operation, or component, and do not exclude one or more additional features.

In the present disclosure, the expressions “A or B”, “at least one of A or/and B”, and “one or more of A or/and B” may include all possible combinations of the items listed. For example, the expressions “A or B”, “at least one of A and B”, and “at least one of A or B” refer to all of (1) including at least one A, (2) including at least one B, or (3) including all of at least one A and at least one B.

The expressions such as “first” and “second” used in the present disclosure may modify various elements regardless of order or importance, and do not limit corresponding elements. The above-described expressions may be used to distinguish an element from another element. For example, a first user device and a second user device indicate different user devices although both are user devices. A first element may be referred to as a second element, and similarly, a second element may be referred to as a first element without departing from the scope of the present disclosure.

When an element, such as a first element, is referred to as being (operatively or communicatively) “connected,” or “coupled,” to another element, such as a second element, the first element may be directly connected or coupled directly to the second element or any other element, such as a third element, may be interposed between the first and second elements. In contrast, when a first element is referred to as being “directly connected,” or “directly coupled” to a second element, there is no third element interposed therebetween.

The expression “configured to” used in the present disclosure may be exchanged with “suitable for”, “having the capacity to”, “designed to”, “adapted to”, “made to”, or “capable of” according to the situation. The expression “configured to” may not necessarily indicate “specially designed to” in terms of hardware. Alternatively, in some situations, the expression “device configured to” may indicate that the device, together with other devices or components, “is able to”. For example, the phrase “processor adapted (or configured) to perform A, B, and C” may indicate a dedicated processor, such as an embedded processor, only for performing the corresponding operations or a generic-purpose processor, such as a central processing unit (CPU) or application processor (AP) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical terms and scientific terms, may have the same meanings as commonly understood by a person of ordinary skill in the art to which the present disclosure pertains. Terms, such as those defined in commonly used dictionaries, should be interpreted as having meanings that are the same or similar to their meaning in the context of the relevant art and will not be interpreted in an idealized or overly formal sense unless expressly so defined herein. In some cases, even a term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), a motion pictures experts group (MEPG) layer audio 3 (MP3) player, a mobile medical appliance, a camera, and a wearable device, such as a head-mounted-device (HMD) including electronic glasses, electronic clothes, an electronic bracelet, an electronic necklace, an electronic appcessory, electronic tattoos, or a smart watch.

In some embodiments, an electronic device may be a smart home appliance such as a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box, such as Samsung HomeSync™, Apple TV™, or Google TV™, a game console, such as Xbox™ and PlayStation™, an electronic dictionary, an electronic key, a camcorder, and an electronic photo frame.

The electronic device may include at least one of various medical devices, such as various portable medical measuring devices including a blood glucose monitoring device, a heart rate monitoring device, a blood pressure measuring device, and a body temperature measuring device, a magnetic resonance angiography (MRA), a magnetic resonance imaging (MRI), a computed tomography (CT) machine, and an ultrasonic machine, a navigation device, a global positioning system (GPS) receiver, an event data recorder (EDR), a flight data recorder (FDR), a vehicle infotainment device, an electronic device for a ship, such as a navigation device and a gyro-compass, avionics, security devices, an automotive head unit, a robot for home or industry, an automatic teller machine (ATM), point of sales (POS) device, or Internet of Things device, such as a light bulb, various sensors, electric or gas meter, a sprinkler device, a fire alarm, a thermostat, a streetlamp, a toaster, a sporting goods, a hot water tank, a heater, or a boiler.

The electronic device may include at least one of a part of furniture or a building/structure, an electronic board, an electronic signature receiving device, a projector, and various types of measuring instruments, such as a water meter, an electric meter, a gas meter, and a radio wave meter. The electronic device may be a combination of one or more of the aforementioned various devices, and may also be a flexible device. The electronic device according to an embodiment of the present disclosure is not limited to the aforementioned devices, and may include a new electronic device according to the development of technology.

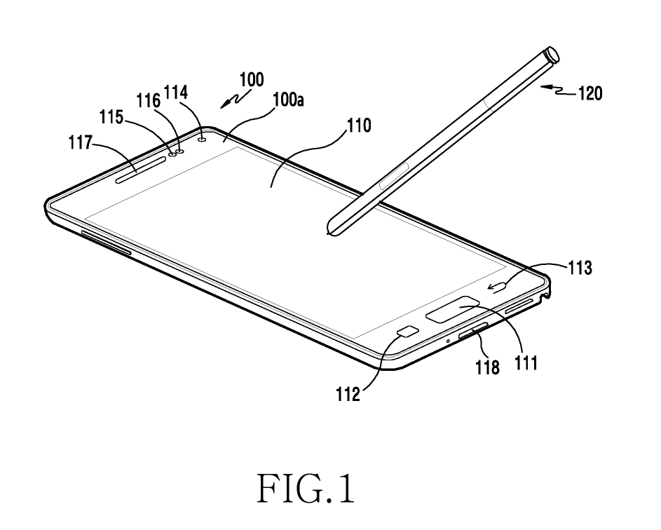

FIG. 1 illustrates the front face of an electronic device according to an embodiment of the present disclosure.

Referring to FIG. 1, an electronic device 100 may include a touch screen 110 that is disposed on the center of the front face 100a thereof. The main home screen of the touch screen 110 may be the first screen to be displayed on the touch screen 110 when the power of the electronic device 100 is turned on. In addition, when the electronic device 100 has several pages of different home screens, the main home screen may be the first home screen among the several pages of different home screens. The home screen may display shortcut icons to execute frequently used applications, a main menu switching key, time, weather, or the like. The main menu switching key may cause the main screen to be displayed on the touch screen 110.

In addition, in the upper end of the touch screen 110 according to embodiments, status bars may be formed to indicate the statuses of the electronic device 100, such as a battery charge status, a received signal strength, and the current time. Below the touch screen 110, a home button 111, a menu button 112, and a back button 113 may be formed.

The home button 111 may cause the main home screen to be displayed on the touch screen 110. For example, when the home button 111 is touched when a home screen, which is different from the main home screen, or the menu screen is displayed on the touch screen 110, the main home screen may be displayed on the touch screen 110. In addition, when the home button 111 is touched while applications are executed on the touch screen 110, the main home screen may be displayed on the touch screen 110. The home button 111 may be used in order to cause the touch screen 110 to display the most recently used application or a task manager.

The menu button 112 may provide a connection menu that may be used on the touch screen 110. The connection menu may include a widget addition menu, a background screen change menu, a retrieve menu, an edition menu, or an environment setting menu.

The back button 113 may cause the screen, which was executed just prior to the currently executed screen, to be displayed, or may cause the most recently used application to be terminated.

A first camera 114, an illuminance sensor 115, and a proximity sensor 116 may be arranged in an edge of the front face 100a of the electronic device 100.

In addition, a USB connector 118 may be arranged on the lower end side face of the electronic device 100. The connector 118 is formed with a plurality of electrodes, and may be connected to an external device via a wire. An earphone connecting jack may be arranged on the upper end side face of the electronic device 100.

A user may input data to the touch screen 110 using an input pen 120.

The touch screen 110 disposed on the front face of the electronic device according to embodiments is not limited to a flat type, and may be configured in a curved type. For example, according to embodiments, one edge region 110c or 110d or opposite edge regions 110c and 110d may be configured in a curved type in the touch screen 110, in which case the front window may also be formed in a corresponding shape, and a flexible display may be applied.

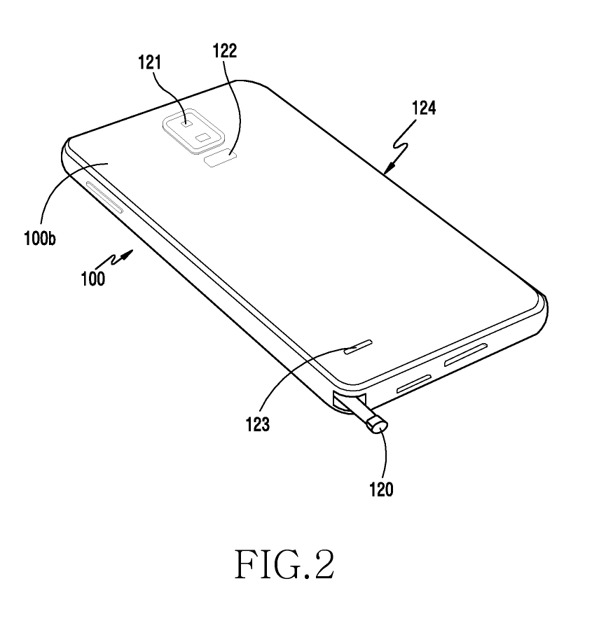

FIG. 2 illustrates the rear face of the electronic device according to embodiments of the present disclosure.

Referring to FIG. 2, a second camera 121, a flash 122, and a speaker 123 may be arranged on the rear face 100b of the electronic device 100.

The rear cover 124 on the rear side of the electronic device 100 may be a battery cover or a back cover. The rear cover 124 may be configured on the rear side of the electronic device as an integrated type or a removably mounting type, and may be formed of a synthetic resin, metal, or glass.

The rear cover 124 does not need to be limited to a flat type, and may be configured in a curved type. For example, one edge region 110e or 110f or opposite edge regions 110e and 110f may be configured in a curved type in the rear cover.

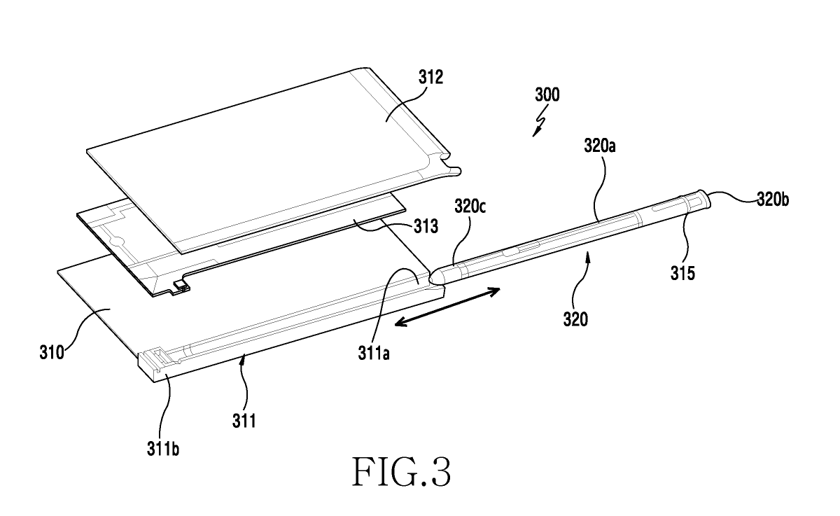

FIG. 3 illustrates an electronic device including an input pen waterproof device according to embodiments of the present disclosure. The electronic device 300 may be the same as the electronic devices 100 illustrated in FIGS. 1 and 2.

Referring to FIG. 3, the electronic device 300 may include a rear case 310, an input pen 320, an input pen insertion section 311, a back cover 312, and a waterproof member 315.

The rear case 310 may be the whole or a portion of the housing of the electronic device 300, and the input pen insertion member 311 may be arranged along one side thereof. For example, the rear case 310 may have a housing, which may include a first face facing in a first direction, a second face facing in a second direction that is opposite to the first direction, and a side face that at least partially encloses a space between the first face and the second face.

The input pen 320 (stylus pen) takes the shape of a writing instrument, and may include a body portion 320a, a head portion 320b, and a grip portion 320c, which may be configured to be integrated with each other.

The rear case 310 may include an opening formed on a side thereof and an input pen insertion section 311 that includes a hole connected to the opening. The input pen insertion section 311 is where the input pen 320 is inserted and fixed, and may include a space that is sufficient for accommodating the input pen 320 inserted therein. The input pen insertion section 311 includes one end 311a and the other end 311b, in which the one end 311a is an inlet region where the input pen 320 is inserted, and the other end 311b may be a closed end where a damper (a contact that performs a damping function) configured to absorb impact generated when the input pen 320 is completely inserted. That is, the inlet may have an opened end shape, and the other end 311b may have a closed end shape.

The input pen 320 may be configured to be at least partly inserted into the inside of the hole, and to be removable from the hole. A memory may store instructions that, upon being executed, cause a processor to determine whether the input pen is detached from the hole using the damper (contact), and to execute one or more actions related to the input pen or the input based on the determination.

The back cover 312 may be formed to be integrated with or removably mounted on the rear case 311. The back cover 312 may be made of a synthetic resin, a metal, a glass material, or a combination thereof. The back cover 312 may be formed to be substantially flat, and at least one edge region of the back cover 312 may be formed to be curved. It is possible to improve the grip feeling of the electronic device by forming the opposite edge regions of the back cover 312 to be curved.

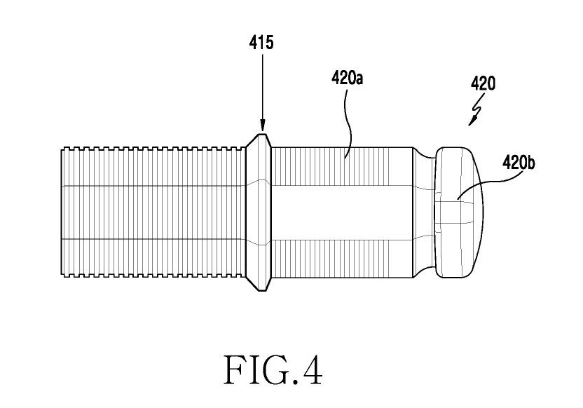

A sealing member 315 may serve as a waterproof member or a friction member, as well as a locking member, and thus, may be referred to as “waterproofing member,” “friction member,” or “locking member.” However, only the term “sealing member” will be used herein. The sealing member 315 may also provide an input pen locking function in addition to the insertion section waterproof function. The sealing member 315 does not need to be limited to being mounted on the input pen 320, and may be mounted in the input pen insertion section 311. FIG. 4 is an exterior of an input pen, which is mounted with a sealing member, according to embodiments of the present disclosure.

Referring to FIG. 4, a waterproof device may include an input pen 420 and a sealing member 415 mounted on the outer surface of the input pen 420. The sealing member 415 may be arranged along at least a portion of the outer surface of the input pen 420, and may be formed to be in contact with the inside of the hole.

The sealing member 415 may be mounted on the outer surface of the input pen as a ring type, in which the sealing member 415 may be arranged on the body portion 420a adjacent to the input head portion 420b. That is, the sealing member 415 may be mounted in a region adjacent to the inlet of the input pen insertion section.

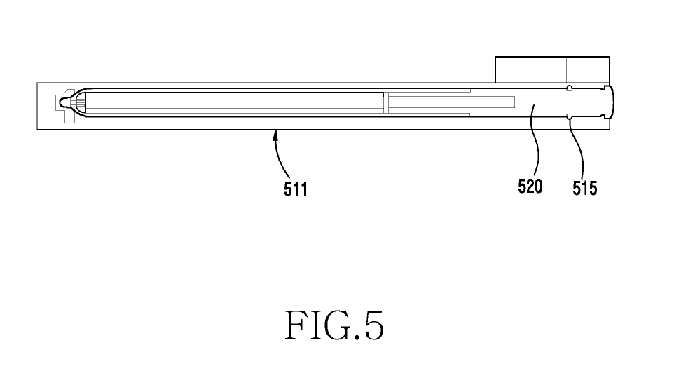

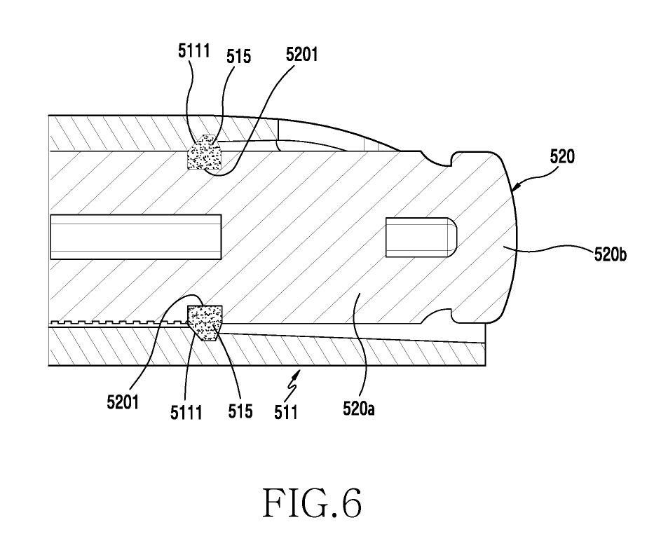

FIG. 5 illustrates when an input pen according to embodiments of the present disclosure is mounted in an input pen insertion section. FIG. 6 illustrates the mounted state of a sealing member when an input pen according to embodiments of the present disclosure is mounted in an input pen insertion section.

Referring to FIGS. 5 and 6, an electronic device including the waterproof device of the input pen according to embodiments may include an input pen insertion section 511, the outer surface of the input pen 520, and a sealing member 515.

One or more waterproof devices may be arranged with reference to the longitudinal direction of the insertion section 511. For example, one waterproof device may be disposed in the region adjacent to one end where the inlet of the insertion section 511 is located, or waterproof devices may be respectively disposed in the region adjacent to the one end and a region adjacent to the other end, which is located opposite to the one end.

The sealing member 515 may be disposed on the head portion 520b (inlet region) of the input pen 520 or on the body portion 520a of the input pen 520 adjacent to the head portion 520b. For this purpose, the input pen 520 may include a first mounting recess 5201 on the outer surface thereof. The first mounting recess 5201 may have a ring shape (when the input pen has a cylindrical shape). The sealing member 515 may be mounted in a structure to be in tightly close contact with the first mounting recess 5201.

The insertion section 511 may have a second mounting recess 5111 in the inlet region, specifically the region that corresponds to the sealing member 515 when the input pen 520 is inserted. The second mounting recess 5111 may be a space where the sealing member 515 may be accommodated and seated.

After the sealing member 515 is mounted in the first mounting recess 5201 or while the input pen is being inserted along the insertion section 511, the sealing member 515 may be in close contact with the inner surface of the insertion section 511, thereby providing a waterproof structure and a locking structure to the inside of the close contact point of the insertion section 515. That is, the inner surface of the sealing member 515 is in close contact with the surface of the first mounting recess 5201, and the outer surface of the sealing member 515 is in close contact with the inner surface of the insertion section 511. Thus, the input pen 520 may have a configuration that may serve as a fixing structure and a waterproof structure in the fixed state.

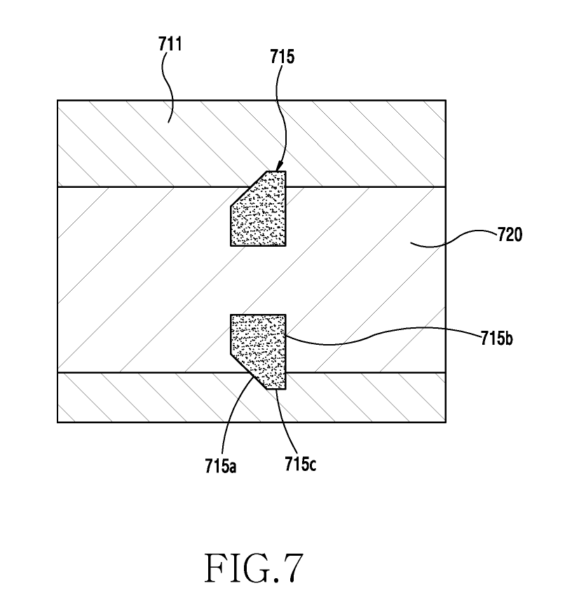

FIG. 7 illustrates the mounted state of the sealing member according to embodiments of the present disclosure.

Referring to FIG. 7, because the direction of inserting an input pen 720 into the insertion section is fixed, the sealing member 715 may be formed in a shape having a directionality and may be mounted in the first mounting recess. The above-mentioned “directionality” may indicates the shape having the directionality that is capable of providing a waterproof structure by being in close contact with the inner surface of the insertion section 711 while allowing the input pen 720, which is mounted with the sealing member 715, to be easily inserted when the sealing member 715 is inserted into the insertion section 711.

The sealing member 715 may include a front face 715a, a rear face 715b, and a side face 715c, in which the front face 715a may refer to a surface that is directed to the inner portion of the insertion section, the rear face 715b may refer to a surface that is directed to the head portion of the input pen 720, and the side face 715c may refer to a surface that faces, and is in close contact with, the inner surface of the insertion section. For example, the front face 715a may be formed as an inclined surface having a large inclined angle, and the rear face 715b may be formed as a flat surface, thereby forming an arrow shape. The shape of the sealing member 715 may seal the inner space in the insertion section 711 while allowing the sealing member 715 to be easily inserted into the insertion section 711.

The sealing member 715 may be made of an elastic rubber material, and thus may be elastically deformed by pressure or external force, and may be tensioned or pressed. The sealing member 715 may be mounted in the first mounting recess 7201 and may be in close contact with the inner surface of the insertion section 711, thereby maintaining the pressed state and enabling the sealing member 715 to provide a force to maintain the locking state of the input pen.

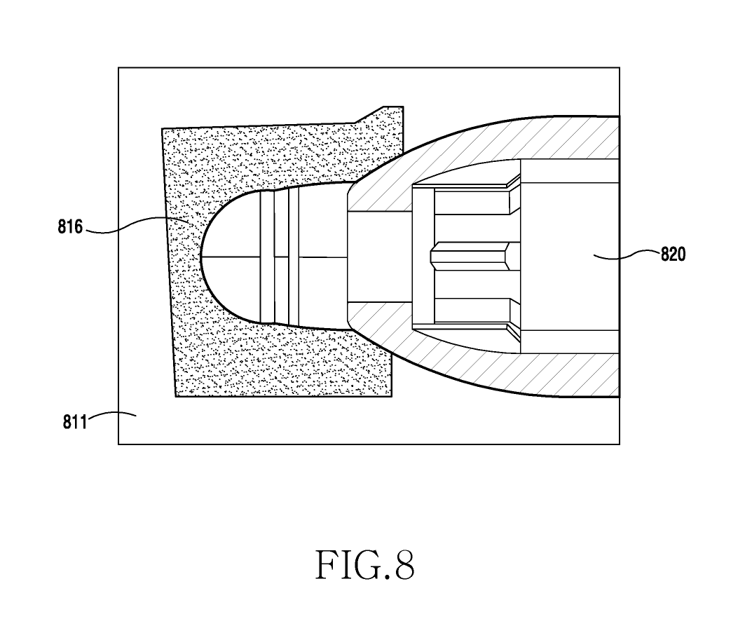

FIG. 8 illustrates when an input pen 820 according to embodiments of the present disclosure is mounted in an insertion section 811 and an end of the input pen 820 is coupled to a damper 816.

Referring to FIG. 8, a damper 816 may be disposed in the closed end of the insertion section 811 of the electronic device according to embodiments. The damper 816 may absorb impact generated when the input pen 820 is inserted into the insertion section 811. The damper 816 may be made of an elastic material, such as rubber. The damper 816 may be formed to have a shape to correspond to the end of the input pen 820 such that the damper 816 may be accommodated to be in close contact with the end of the input pen 820 when the input pen 820 is mounted. For example, the accommodation space provided in the damper 816 may be formed to have a size slightly smaller than the end of the input pen 820, such that when the end of the input pen 820 is inserted into the input pen 820, the damper 816 may provide a secondary locking function of holding the inserted end (i.e., fixing the inserted input pen 820).

An input pen waterproof device may be mounted in the insertion section of the rear case provided in an electronic device.

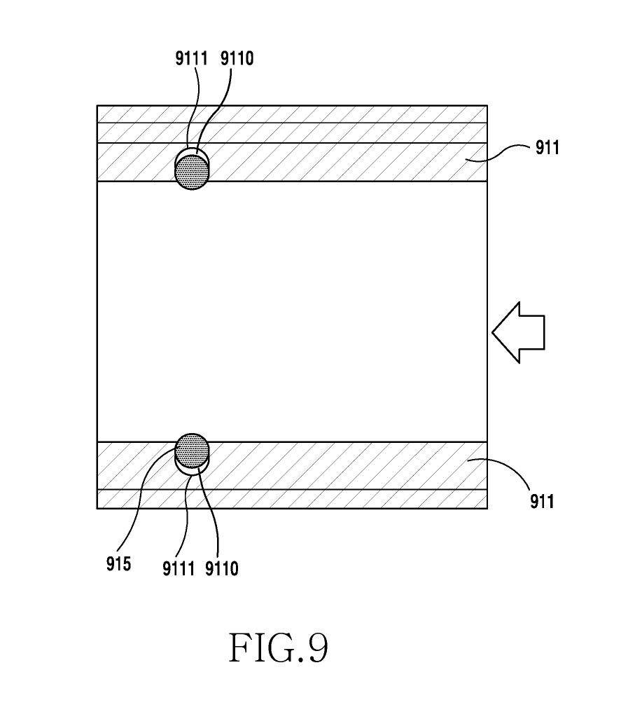

FIG. 9 illustrates when a sealing member 915 according to embodiments of the present disclosure is mounted on the inner surface of an insertion section 911.

Referring to FIG. 9, the sealing member 915 may be mounted on the inner surface of the insertion section 911, where a mounting recess 9111 may be formed so as to mount a sealing member therein.

When the input pen is inserted into the accommodation space of the insertion section 911, the mounting recess 9111 may cause the sealing member 915 and the outer surface of the input pen to closely contact each other. Accordingly, the radial size of the sealing member 915 may slightly increase. In consideration of this, the mounting recess 9111 may be configured to provide a marginal accommodation space 9110 in a size that sufficiently allows the sealing member 915 to move outward.

The vertical cross-section of the sealing member may preferably be a circular shape, but may take various cross-sectional shapes as will be described later herein. For example, the cross section of the sealing member may have a directionality to facilitate the input pen mounting/removing operation while performing waterproof and locking functions.

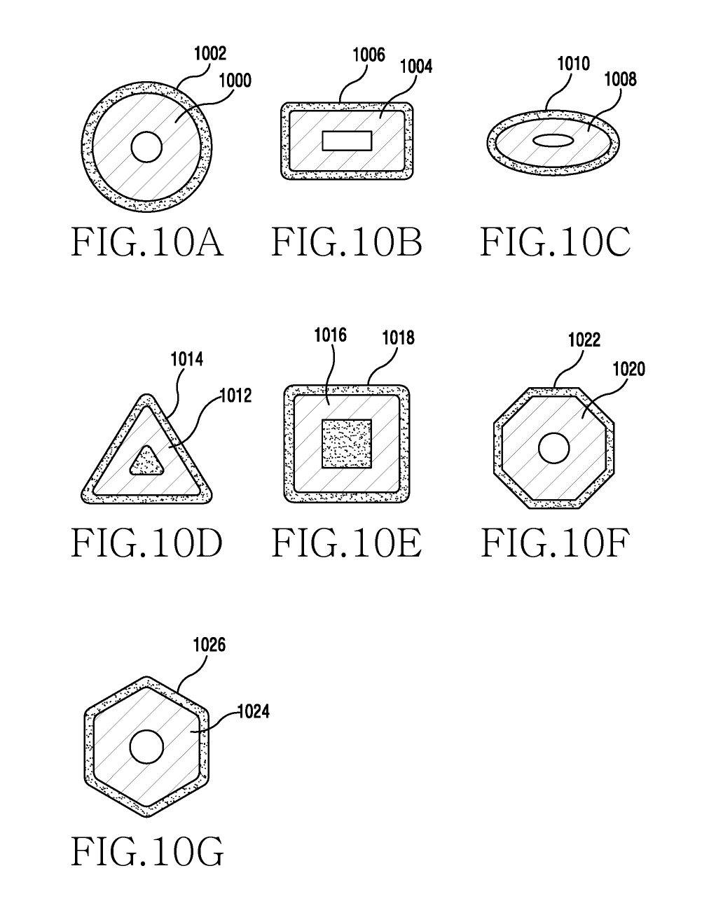

FIGS. 10A, 10B, 10C, 10D, 10E, 10F and 10G are sectional views each illustrating an input pen that is mounted with a sealing member according to embodiments of the present disclosure.

Referring to FIGS. 10A, 10B, 10C, 10D, 10E, 10F and 10G, the input pen according to embodiments is an input device having the shape of a writing instrument, and may be formed in various shapes.

In FIG. 10A, an input pen 1000, which is mounted with a sealing member 1002, may have a substantially hollow circular shape in cross section.

In FIG. 10B, an input pen 1004, which is mounted with a sealing member 1006, may have a substantially hollow rectangular shape in cross section. Each of the angled portions of the input pen 1004 (four outer corner regions) may have a curvature.

In FIG. 10C, an input pen 1008, which is mounted with a sealing member 1010, may have a substantially hollow oval shape in cross section.

In FIG. 10D, an input pen 1012, which is mounted with a sealing member 1014, may have a substantially hollow triangular shape in cross section. Each of the angled portions of the input pen 1012 (three outer corner regions) may have a curvature.

In FIG. 10E, an input pen 1016, which is mounted with a sealing member 1018, may have a substantially hollow square shape in cross section. Each of the angled portions of the input pen 1016 (four outer corner regions) may have a curvature.

In FIG. 10F, an input pen 1020, which is mounted with a sealing member 1022, may have a substantially hollow octagonal shape in cross section. Each of the angled portions of the input pen 1020 (eight outer corner regions) may have a curvature.

In FIG. 10G, an input pen 1024, which is mounted with a sealing member 1026, may have a substantially hollow hexagonal shape in cross section. Each of the angled portions of the input pen 1024 (six outer corner regions) may have a curvature.

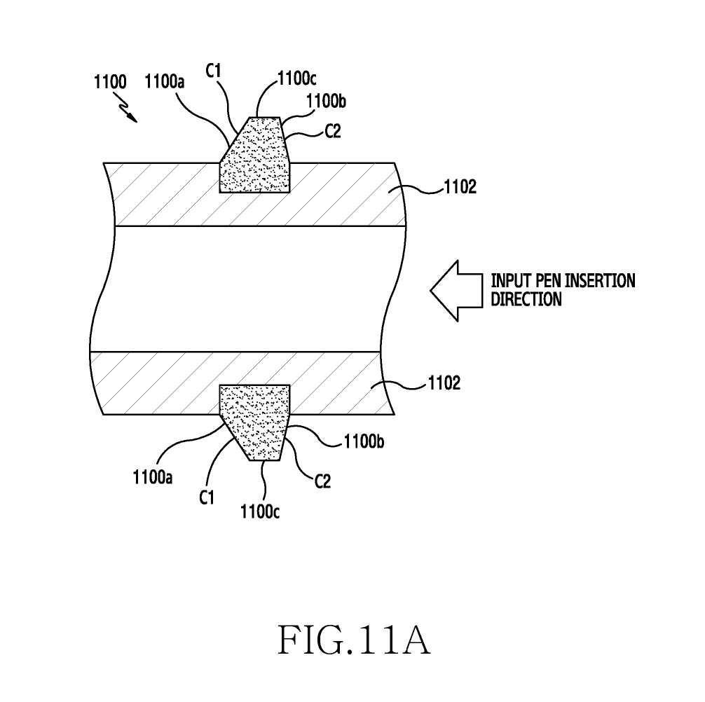

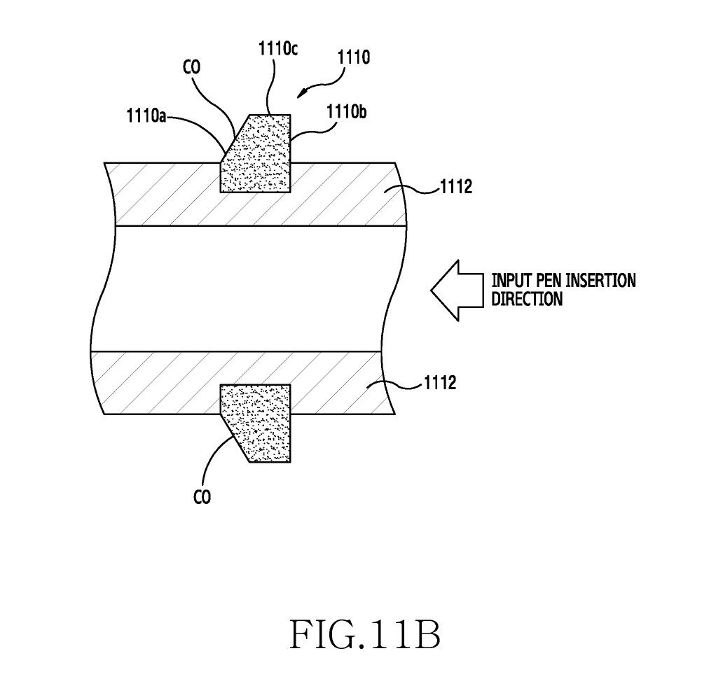

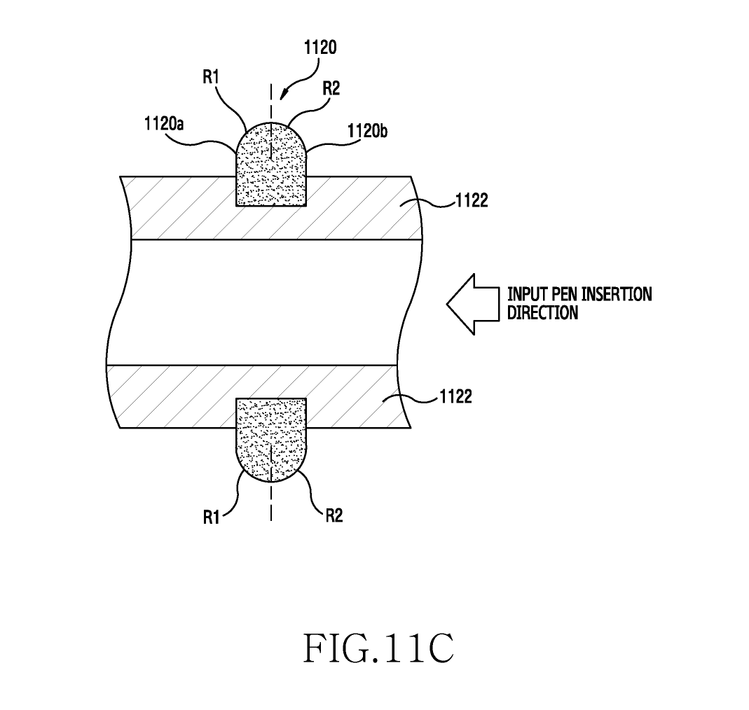

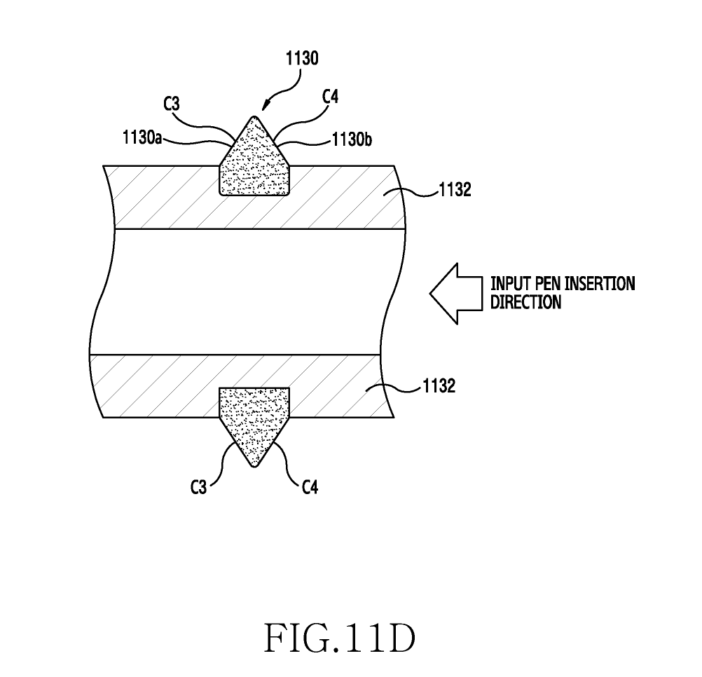

Descriptions will be made on the various shapes of the sealing member according to embodiments of the present disclosure with reference to FIGS. 11A, 11B, 11C and 11D. The sealing member is substantially ring-shaped, and may perform a waterproof function and a locking function. For example, due to the insertion direction of the input pen, the sealing member may be formed in a shape having a directionality, and may be formed in a shape that is capable of maintaining the close contact state with the inner surface of the insertion section while facilitating the movement in the direction opposite to the insertion.

Referring to FIG. 11A, the sealing member 1100 may be substantially ring-shaped, and one or more sealing members 1100 may be mounted on the outer surface of the input pen 1102.

The outer surface of the sealing member 1100 is to be in close contact with the inner surface of the insertion section, and may include a first face that forms a first angle with respect to the outer surface of the input pen and a second face that forms a second angle with respect to the outer surface of the input pen. The sealing member 1100 may include a front face 1100a, which is the first face, a rear face 1100b, which is the second face, and a side face 1100c. The sealing member 1100 should have a directional shape, and may have an arrow shape.

In order for the sealing member 1100 to have the directional shape in the insertion direction, the front face 1100a and the rear face 1100b should be chamfered. The rear surface 1100b may be chamfered to be closer to a vertical plane than the front face 1100a. The chamfering degree may be expressed by a C (chamfer) value, and the C value of the front face 1100a (C1) may be larger than the C value of the rear face 1100b (C2). The angled portions between the front and rear faces 1100a and 1100b and the side face 1100c may be formed in a shape having a curvature. A large arrow may indicate the insertion direction of the input pen 1100.

Referring to FIG. 11B, the outer surface of the sealing member 1110 is to be in close contact with the inner surface of the insertion section, and may include a front face 1110a, a rear face 1110b, and a side face 1110c. The sealing member 1110 should have a directional shape, and may have an arrow shape. In order for the sealing member 1110 to have the directional shape in the insertion direction, the front face 1110a should be chamfered and the rear face 1110b may be formed as a vertical plane without being chamfered. That is, the front face may have a C value, but the rear face may not have a C value (C0). A large arrow may indicate the insertion direction of the input pen 1110.

Referring to FIG. 11C, the outer surface of the sealing member 1120 is to be in close contact with the inner surface of the insertion section, and may include a front outer circumferential face 1120a and a rear outer circumferential face 1120b, which have a radius. The sealing member 1120 may be formed to have a shape that may be easily in close contact with the inner surface of the insertion section while smoothly moving in the mounting/removing direction of the input pen 1122. The curvature R1 of the front outer circumferential surface 1120a and the curvature R2 of the rear circumferential surface 1120b may be equal to or different from each other. For example, the front and rear circumferential surfaces 1120a and 1120b of the sealing member may slightly protrude from the outer surface of the input pen 1120, thereby improving the close contact with the inner surface of the insertion section. A large arrow may indicate the insertion direction of the input pen 1120.

Referring to FIG. 11D, the outer surface of the sealing member 1130 is to be in close contact with the inner surface of the insertion section, and may include a front face 1130a and a rear face 1130b. The sealing member 1130 should have a directional shape, and may have an arrow shape. In order for the sealing member 1130 to have the directional shape in the insertion direction, the front face 1130a should be chamfered (corner-cut), and the rear face 1130b may be chamfered in the manner of the front surface 1130a. The chamfering degree may be expressed by a C (chamfer) value, and the C value of the front face 1130a (C3) may be equal to the C value of the rear face 1130b (C4). The angled portions between the front face 1130a and rear face 1130b may be formed in a shape having a curvature. A large arrow may indicate the insertion direction of the input pen 1130.

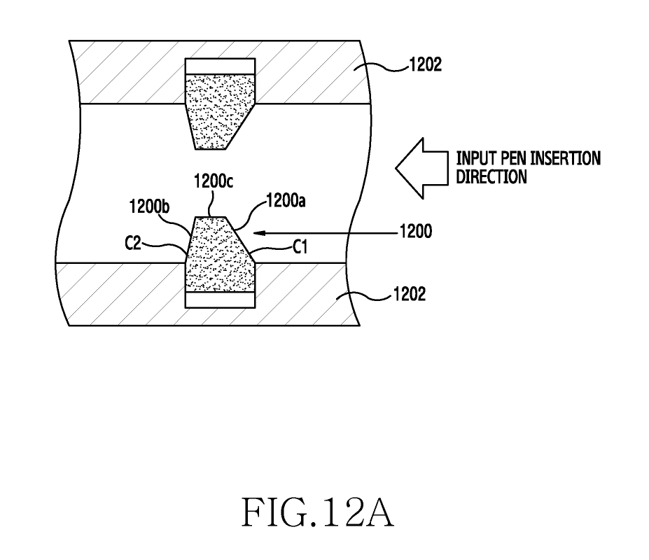

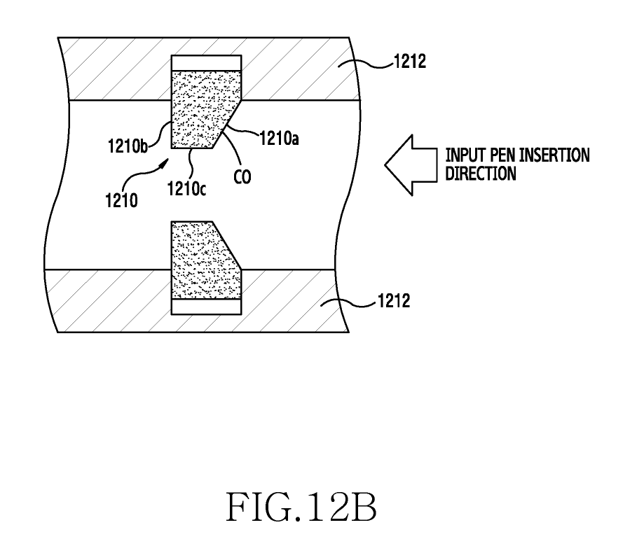

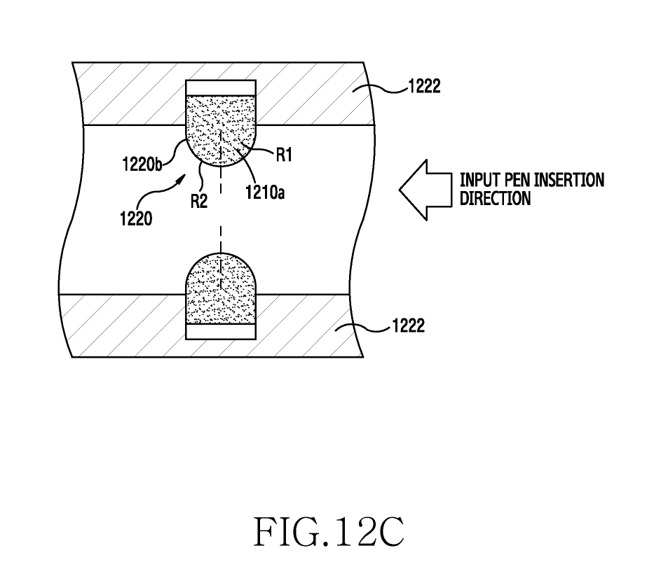

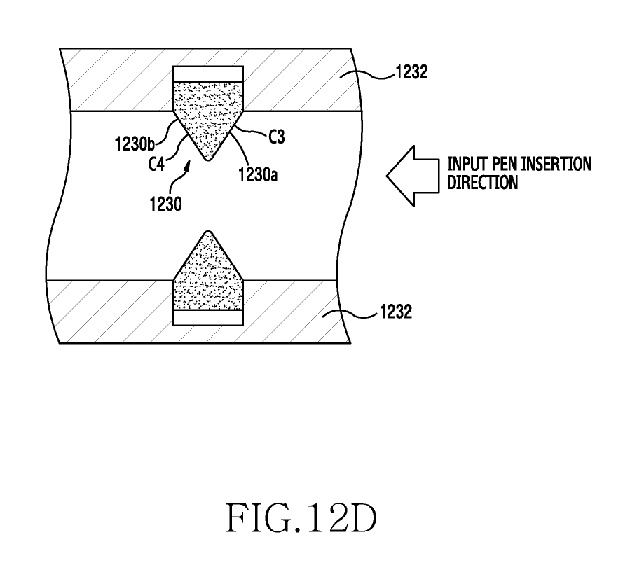

Descriptions will be made on the various shapes of the sealing member to be mounted in an insertion section of an electronic device according to embodiments of the present disclosure with reference to FIGS. 12A, 12B, 12C and 12D. The sealing member is substantially ring-shaped, and may perform a waterproof function and a locking function. For example, due to the insertion direction of the input pen, the sealing member according to embodiments may be formed in a shape having a directionality, and may be formed in a shape that is capable of maintaining the close contact state with the outer surface of the input pen while facilitating the movement in the direction opposite to the insertion.

Referring to FIG. 12A, the sealing member 1200 may be substantially ring-shaped, and one or more sealing members 1200 may be mounted on the inner surface of the insertion section 1202.

The outer surface of the sealing member 1200 is to be in close contact with the outer surface of the input pen, and may include a front face 1200a, a rear face 1200b, and a side face 1200c. The sealing member 1200 should have a directional shape, and may have an arrow shape. In order for the sealing member 1200 to have the directional shape in the insertion direction, the front face 1200a should be chamfered, and the rear face 1200b may be chamfered to be closer to a vertical plane than the front face 1200a. The chamfering degree may be expressed by a C (chamfer) value, and the C value of the front face 1200a (C1) may be larger than the C value of the rear face 1200b (C2). The angled portions between the front and rear faces 1200a and 1200b and the side face 1200c may be formed in a shape having a curvature. A large arrow may indicate the insertion direction of the input pen. When the sealing member is mounted in the mounting recess of the insertion section, a marginal space may be provided in which the sealing member moves.

Referring to FIG. 12B, the outer surface of the sealing member 1210 is to be in close contact with the outer surface of the input pen, and may include a front face 1210a, a rear face 1210b, and a side face 1210c. The sealing member 1210 should have a directional shape, and may have an arrow shape. In order for the sealing member 1210 to have the directional shape in the insertion direction, the front face 1210a should be chamfered and the rear face 1210b may be formed as a vertical plane without being chamfered. That is, the front face may have a C value, but the rear face may not have a C value (C0). A large arrow may indicate the insertion direction of the input pen.

Referring to FIG. 12C, the outer surface of the sealing member 1220 is to be in close contact with the inner surface of the insertion section, and may include a front outer circumferential face 1220a and a rear outer circumferential face 1220b, which have a radius. The sealing member 1220 may be formed to have a shape that may be easily in close contact with the outer surface of the input pen. The curvature R1 of the front outer circumferential surface 1220a and the curvature R2 of the rear circumferential surface 1220b may be equal to or different from each other. For example, the front and rear circumferential surfaces 1220a and 1220b of the sealing member may slightly protrude from the inner surface of the insertion section, thereby improving the close contact with the outer surface of the input pen. A large arrow may indicate the insertion direction of the input pen.

Referring to FIG. 12D, the outer surface of the sealing member 1230 is to be in close contact with the outer surface of the input pen, and may include a front face 1230a and a rear face 1230b. The sealing member 1230 should have a directional shape, and may have an arrow shape. In order for the sealing member 1230 to have the directional shape in the insertion direction, the front face 1230a should be chamfered, and the rear face 1230b may be chamfered like the front surface 1130a. The chamfering degree may be expressed by a C (chamfer) value, and the C value of the front face 1230a (C3) may be equal to the C value of the rear face 1230b (C4). The angled portions between the front face 1230a and rear face 1230b may be formed in a shape having a curvature. A large arrow may indicate the insertion direction of the input pen.

According to embodiments of the present disclosure, in an electronic device on which an input pen is removably mounted, it is possible to prevent foreign matters such as water or dust from entering the electronic device.

Furthermore, it is possible to seal the inside of the electronic device while fixing the input pen by using a sealing member, which is a basic component.

Embodiments of the present disclosure may provide a simplified mounting/removal and a smooth mounting/removing feeling.

The following are aspects according to embodiments of the present disclosure. An electronic device may include: a housing that includes a first face that is directed to a first direction, a second face that is directed opposite to the first direction, and a side face that at least partially encloses a space between the first face and the second face, an opening that is formed in the side face of the housing, a hole continued to the opening; a contact disposed inside the hole, a stylus pen configured to be at least partially inserted into the hole, and to be removable from the hole, a friction member arranged on at least a portion of an outer surface of the stylus pen, and formed to be in contact with an inner portion of the hole, a display module exposed to the first face of the housing, and configured to receive an input through the stylus pen, a processor electrically connected to the display module, and a memory electrically connected to the processor. The memory may store instructions that, when executed, cause the processor to determine whether the stylus pen is removed from the hole using the contact, and to execute at least one action related to the stylus pen or the input based on the determination.

The friction member may include a first face that forms a first angle with respect to an outer surface of the stylus pen, and a second face that forms a second angle with respect to the outer surface of the stylus pen, and may be formed of rubber.

An electronic device may include a case, an input pen inserted into the case, and at least one sealing member mounted on an outer surface of the input pen such that at least a portion of the sealing member protrudes outward. When the input pen is mounted in the case, at least a portion of the input pen may be in close contact with an inner surface of the case so as to seal an inner portion of the case.

The sealing member may be formed in a shape having a directionality in a direction of inserting the input pen.

The sealing member may be formed of a rubber material in a ring shape, and may be mounted in a first mounting recess formed in a ring shape along the outer surface of the input pen.

The sealing member may have a front face, a side face, and a rear face, and the front face may have a first inclined surface formed by chamfering.

The sealing member may have a second inclined surface formed by chamfering on the rear face, and the second inclined surface may have a smaller C value than the first inclined surface.

The input pen may include a body portion and a head portion located at an end of the body portion, and the sealing member may be disposed on the body portion adjacent to the head portion.

The sealing member may serve as a locker that prevents a movement of the input pen by friction with the inner surface of the case.

One end of the case may be an inlet of the input pen and may be formed as an opened end, and another end of the case may be formed as a closed end in which a damper is disposed to fix the inserted input pen.

The case may further include a second mounting recess formed on the inner surface to accommodate the sealing member of the mounted input pen.

The first mounting recess and the second mounting recess may be arranged to face each other when the input pen is mounted in the case.

An electronic device may include a rear case, an input pen insertion section formed in the rear case, one or more sealing members arranged on a first face of the insertion section along a direction of mounting/removing the input pen such that the sealing members partially protrude from the first face of the insertion section. When the input pen is inserted, the sealing member may fix the inserted input pen while sealing an inner portion of the insertion section by being in close contact with the input pen.

The sealing member may be ring-shaped, and a ring-shaped mounting recess may be formed on an inner surface of the insertion section such that the sealing member may be seated in the mounting recess.

The mounting recess may provide a marginal space where at least a portion of the sealing member is movable by an operation of causing the sealing member to be in close contact with the input pen.

An electronic device may include a rear case, a back cover coupled to the rear case, an input pen insertion section arranged along a side of the rear case, an input pen configured to be mounted in/removed from the input pen insertion section, at least one sealing member mounted on an outer surface of the input pen, and configured to primarily fix the input pen while sealing an inner portion of the case by being at least partially in close contact with an inner surface of the case; and a damper disposed in the input pen insertion section to secondarily fix the input pen inserted into the input pen insertion section.

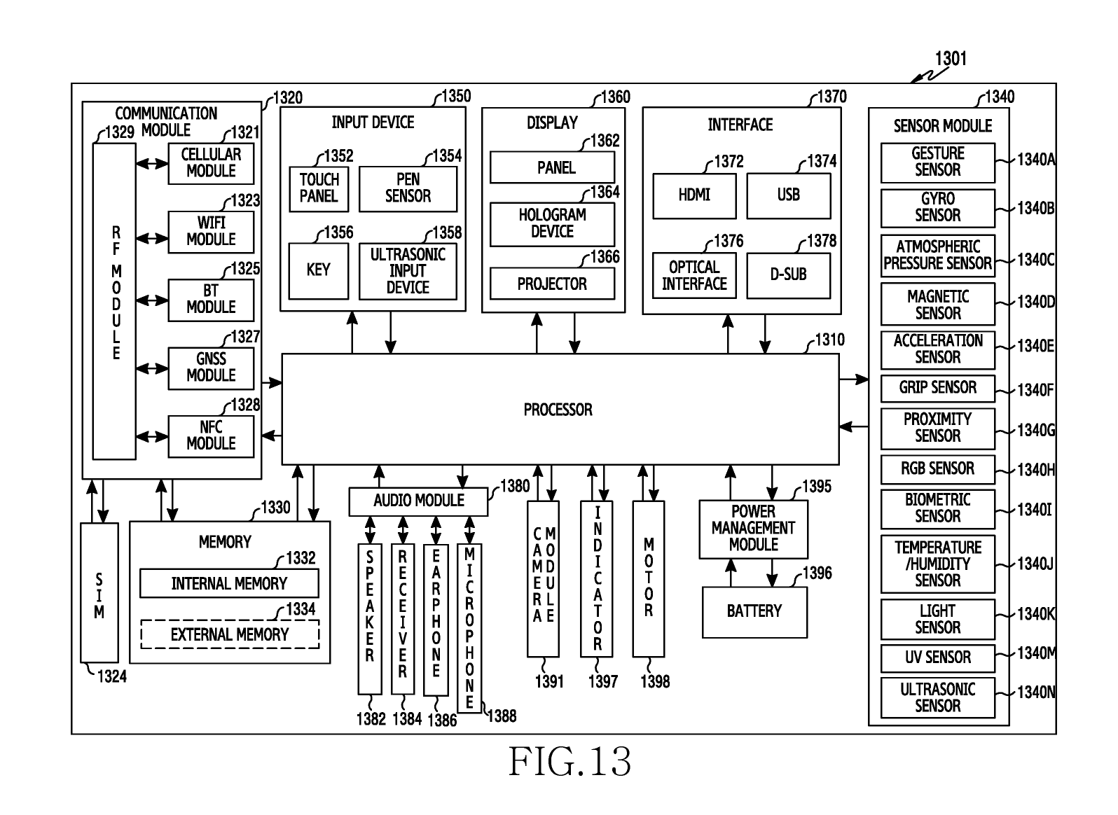

FIG. 13 is a block diagram of an electronic device, according to the present disclosure.

Referring to FIG. 13, the electronic device 1301 includes an application processor (AP) 1310, a communication module 1320, a subscriber identification module (SIM) card 1324, a memory 1330, a sensor module 1340, an input device 1350, a display 1360, an interface 1370, an audio module 1380, a camera module 1391, a power management module 1395, a battery 1396, an indicator 1397, and a motor 1398.

The AP 1310 runs an operating system or an application program to control a plurality of hardware or software constituent elements connected to the AP 1310, and may perform processing and operation of various data including multimedia data. The AP 1310 may be implemented as a system on chip (SoC). The AP 1310 further includes a graphical processing unit (GPU) and at least one of other constitute elements, such as the cellular module 1321. The AP 210 loads an instruction or data, which is received from a non-volatile memory connected to each or at least one of other constituent elements, to a volatile memory and processes the loaded instruction or data. In addition, the AP 210 stores in the non-volatile memory, data received from at least one of the other constituent elements or generated by at least one of the other constituent elements.

The communication module 1320 performs data transmission/reception in communication between the electronic device 1301 and other electronic devices connected through a network. According to an embodiment of the present disclosure, the communication module 1320 includes cellular module 1321, a wireless fidelity (Wi-Fi) module 1323, a Bluetooth (BT) module 1325, a global positioning system (GPS) module 1327, a near field communication (NFC) module 1328, and a radio frequency (RF) module 1329.

The cellular module 1321 provides a voice telephony, a video telephony, a text service, and an Internet service, through a telecommunication network, such as long term evolution (LTE), LTE-Advanced (LTE-A), code division multiple access (CDMA), wideband CDMA (WCDMA), universal mobile telecommunications system (UMTS), wireless broadband (WiBro), and global system for mobile communications (GSM). In addition, the cellular module 1321 may use a SIM card 1324 to perform electronic device distinction and authorization within the telecommunication network.

The cellular module 1321 may perform at least some of functions that the AP 1310 may provide. For example, the cellular module 1321 performs at least one part of a multimedia control function.

The WiFi module 1323, the BT module 1325, the GPS module 1327 and the NFC module 1328 each may include a processor for processing data transmitted/received through the corresponding module. According to an embodiment of the present disclosure, at least two of the cellular module 1321, the WiFi module 1323, the BT module 1325, the GPS module 1327 and the NFC module 1328 are included within one IC or IC package.

The RF module 1329 performs transmission/reception of data such as an RF signal. The RF module 1329 may include a transceiver, a power amplifier module (PAM), a frequency filter, a low noise amplifier (LNA), and an antenna. According to an embodiment of the present disclosure, at least one of the cellular module 1321, the WiFi module 1323, the BT module 1325, the GPS module 1327 or the NFC module 1328 may perform transmission/reception of an RF signal through a separate RF module.

The SIM card 1324 includes a SIM, and may be inserted into a slot provided in a specific position of the electronic device 1301. The SIM card 1324 includes unique identification information, such as an integrated circuit card ID (ICCID) or subscriber information, such as an international mobile subscriber identity (IMSI).

The memory 1330 includes an internal memory 1332 or an external memory 1334. The internal memory 1332 includes at least one of a volatile memory, such as a dynamic random access memory (DRAM), a static RAM (SRAM) and a synchronous DRAM (SDRAM), or a non-volatile memory, such as a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, and a not or (NOR) flash memory.

The internal memory 1332 may be a solid state drive (SSD). The external memory 1334 may further include a flash drive such as compact flash (CF), secure digital (SD), micro-SD, mini-SD, extreme digital (xD), and a memory stick. The external memory 1334 may be operatively connected with the electronic device 1301 through various interfaces.

The sensor module 1340 measures a physical quantity or detects an activation state of the electronic device 101, and converts measured or detected information into an electric signal. The sensor module 1340 includes at least one of a gesture sensor 1340A, a gyro sensor 1340B, an air pressure sensor 1340C, a magnetic sensor 1340D, an acceleration sensor 1340E, a grip sensor 1340F, a proximity sensor 1340G, a color sensor 1340H, such as a red, green, blue (RGB) sensor, a bio-physical sensor 1340I, a temperature/humidity sensor 1340J, an illumination sensor 1340K, a ultraviolet (UV) sensor 1340M, and the like. Additionally or alternatively, the sensor module 1340 may also include an E-nose sensor, an electromyography (EMG) sensor, an electroencephalogram (EEG) sensor, an electrocardiogram (ECG) sensor, an infrared (IR) sensor, an iris sensor, a fingerprint sensor, and the like. The sensor module 1340 may further include a control circuit for controlling at least one or more sensors belonging therein.

The input device 1350 includes a touch panel 1352, a (digital) pen sensor 1354, a key 1356, and an ultrasonic input device 1358. The touch panel 1352 may detect a touch input in at least one of a capacitive overlay scheme, a pressure sensitive scheme, an infrared beam scheme, and an acoustic wave scheme. The touch panel 1352 may also include a control circuit. In the capacitive overlay scheme, physical contact or proximity detection is possible. The touch panel 1352 may further include a tactile layer, to provide a tactile response to a user.

The (digital) pen sensor 1354 may be implemented in the same or similar method to receiving a user's touch input or by using a separate sheet for detection. The key 1356 may include a physical button, an optical key, or a keypad. The ultrasonic input device 1358 is capable of identifying data by detecting a sound wave in the electronic device 1301 through an input tool generating an ultrasonic signal, and enables wireless detection. According to an embodiment of the present disclosure, the electronic device 1301 may also use the communication module 1320 to receive a user input from a connected external device, such as a computer or a server.

The display 1360 includes a panel 1362, a hologram device 1364, or a projector 1366. The panel 1362 may be an LCD, or an Active-Matrix Organic LED (AMOLED), for example. The panel 1362 may be implemented to be flexible, transparent, or wearable. The panel 1362 may be constructed as one module along with the touch panel 1352 as well. The hologram device 1364 may use interference of light to show a three-dimensional image in the air. The projector 1366 may project light to a screen to display an image. The screen may be located inside or outside the electronic device 1301. According to an embodiment of the present disclosure, the display 1360 may further include a control circuit for controlling the panel 1362, the hologram device 1364, or the projector 1366.

The interface 1370 includes a high-definition multimedia interface (HDMI) 1372, a universal service bus (USB) 1374, an optical interface 1376, or a D-subminiature (D-sub) 1378. Additionally or alternatively, the interface 1370 includes a mobile high-definition link (MHL) interface, an SD card/multimedia card (MMC) interface or an infrared data association (IrDA) standard interface.

The audio module 1380 converts a voice and an electric signal interactively. The audio module 1380 may process sound information which is inputted or outputted through a speaker 1382, a receiver 1384, an earphone 1386, or the microphone 1388.

The camera module 1391 takes still pictures and moving pictures. The camera module 1391 includes one or more image sensors, such as a front sensor or a rear sensor, a lens, an image signal processor (ISP), or a flash, such as an LED or a xenon lamp.

The power management module 1395 manages electric power of the electronic device 1301 and includes a power management integrated circuit (PMIC), a charger IC, a battery, and a battery gauge.

The PMIC may be mounted within an integrated circuit or an SoC semiconductor. A charging scheme may be divided into a wired charging scheme and a wireless charging scheme. The charger IC charges the battery 1396, and prevents the inflow of overvoltage or overcurrent from an electric charger. The charger IC includes a charger IC for at least one of the wired charging scheme or the wireless charging scheme. The wireless charging scheme may be a magnetic resonance scheme, a magnetic induction scheme, an electromagnetic wave scheme, and the like. A supplementary circuit for wireless charging including a circuit, such as a coil loop, a resonance circuit, and a rectifier, may be added.

The battery gauge may measure a level of the battery 1396, a voltage during charging, a current or a temperature. The battery 1396 generates or stores electricity, and uses the stored or generated electricity to supply power to the electronic device 1301. The battery 1396 may include a rechargeable battery or a solar battery.

The indicator 1397 displays a specific status of the electronic device 1301 or one part thereof, for example a booting, message, or charging state. The motor 1398 may convert an electric signal into a mechanical vibration. The electronic device 101 may include a processing device, such as a GPU for mobile TV support. The processing device for mobile TV support may process media data according to the standards of digital multimedia broadcasting (DMB), digital video broadcasting (DVB), and media flo.

Each of the above-described elements of the electronic device may include one or more components, and the name of a corresponding element may vary according to the type of electronic device. The electronic device according to the present disclosure may include at least one of the above-described elements and may exclude some of the elements or further include other additional elements. Some of the elements of the electronic device according to the present disclosure may be coupled to form a single entity while performing the same functions as those of the corresponding elements before the coupling.

The term “module,” as used herein may represent a unit including a combination of one or two or more of hardware, software, or firmware. The “module” may be used interchangeably with the terms “unit”, “logic”, “logical block”, “component”, or “circuit” etc. The “module” may be the minimum unit of an integrally constructed component or a part thereof. The “module” may be also the minimum unit performing one or more functions or a part thereof. The “module” may be implemented mechanically or electronically. For example, the “module” may include at least one of an application-specific integrated circuit (ASIC) chip, field programmable gate arrays (FPGAs) and a programmable-logic device performing some operations known to the art or to be developed in the future.

At least a part of an apparatus, such as modules or functions thereof, or a method according to the present disclosure may be implemented as instructions stored in a computer-readable storage medium in a form of a programming module. When the instruction is executed by a processor, the processor may perform functions corresponding to the instructions. The computer-readable storage media may be the memory 130, for instance.

The computer-readable recording medium may include a hard disk, a floppy disk, and a magnetic medium, such as a magnetic tape, an optical medium, such as a compact disc-read only memory (CD-ROM) and a digital versatile disc (DVD)), a magneto-optical medium, such as a floptical disk, and a hardware device, such as a ROM, a random access memory (RAM), and a flash memory. The program instruction may include not only a mechanical language code such as a code made by a compiler but also a high-level language code executable by a computer using an interpreter, etc. The aforementioned hardware device may be constructed to operate as one or more software modules in order to perform operations of the present disclosure, and vice versa.

The module or programming module according to the present disclosure may include at least one or more of the aforementioned constituent elements, or omit some of the aforementioned constituent elements, or further include additional other constituent elements. Operations carried out by the module, the programming module or the other constituent elements according to the present disclosure may be executed in a sequential, parallel, repeated or heuristic method. Also, some operations may be executed in different order or may be omitted, or other operations may be added.

Accordingly, a method and electronic device are provided for controlling a display according to the present disclosure, to determine the priority of display based on a user's preference, thereby decreasing a search time for display and more quickly displaying a desired screen.

While the present disclosure has been shown and described with reference to certain embodiments thereof, it will be apparent to those skilled in the art that the present disclosure is not limited to these embodiments, and various changes in form and details may be made therein without departing from the spirit and scope of the present disclosure as defined by the appended claims.

What is claimed is:

1. An electronic device comprising:
a housing that includes a first face that is directed in a first direction, a second face that is directed opposite to the first direction, and a side face that at least partially encloses a space between the first face and the second face;
an opening that is formed in the side face of the housing;
a hole connected to the opening;
a contact disposed inside the hole;
a stylus pen configured to be at least partially inserted into the hole, and to be removable from the hole;
a friction member arranged on at least a portion of an outer surface of the stylus pen, and formed to be in contact with an inner portion of the hole;
a display module exposed to the first face of the housing, and configured to receive an input through the stylus pen;
a processor electrically connected to the display module; and
a memory electrically connected to the processor,
wherein the memory stores instructions that, when executed, cause the processor to determine whether the stylus pen is removed from the hole using the contact, and to execute at least one action related to the stylus pen or the input based on the determination.

2. The electronic device of claim 1, wherein the friction member comprises a first face that forms a first angle with respect to an outer surface of the stylus pen, and a second face that forms a second angle with respect to the outer surface of the stylus pen.

3. The electronic device of claim 1, wherein the friction member is formed of rubber.

4. An electronic device comprising:
a case;
an input pen inserted into and removable from the case; and
at least one sealing member mounted on an outer surface of the input pen such that at least a portion of the sealing member protrudes outward,
wherein, when the input pen is mounted in the case, at least a portion of the input pen is in close contact with an inner surface of the case and seals an inner portion of the case.

5. The electronic device of claim 4, wherein the sealing member is formed in a shape having a directionality.

6. The electronic device of claim 5, wherein the sealing member is formed to have a directionality in a direction in which the input pen is inserted.

7. The electronic device of claim 6, wherein the sealing member is formed of a rubber material in a ring shape, and is mounted in a first mounting recess formed in the ring shape along the outer surface of the input pen.

8. The electronic device of claim 7, wherein the sealing member has a front face, a side face, and a rear face, and the front face has a first inclined surface formed by chamfering.

9. The electronic device of claim 8, wherein the sealing member has a second inclined surface formed by chamfering on the rear face, and the second inclined surface has a smaller chamfer value than the first inclined surface.

10. The electronic device of claim 4, wherein the input pen includes a body portion and a head portion located at an end of the body portion, and the sealing member is disposed on the body portion adjacent to the head portion.

11. The electronic device of claim 4, wherein the sealing member serves as a locker that prevents a movement of the input pen by friction with the inner surface of the case.

12. The electronic device of claim 4, wherein one end of the case is an inlet of the input pen and is formed as an opened end, and another end of the case is formed as a closed end in which a damper is disposed to fix the inserted input pen.

13. The electronic device of claim 7, wherein the housing further includes a second mounting recess formed on the inner surface to accommodate the sealing member of the mounted input pen.

14. The electronic device of claim 13, wherein the first mounting recess and the second mounting recess face each other when the input pen is mounted in the housing.

15. An electronic device comprising:
a rear case;
an input pen insertion section formed in the rear case; and
one or more sealing members arranged on a first face of the insertion section along a direction of mounting and removing the input pen such that the sealing members partially protrude from the first face of the insertion section,
wherein, when the input pen is inserted, the sealing member fixes the inserted input pen while sealing an inner portion of the insertion section by being in close contact with the input pen.

16. The electronic device of claim 15, wherein the sealing member is ring-shaped, and a ring-shaped mounting recess is formed on an inner surface of the insertion section such that the sealing member is seated in the mounting recess.

17. The electronic device of claim 16, wherein the mounting recess provides a marginal space where at least a portion of the sealing member is movable by an operation of causing the sealing member to be in close contact with the input pen.

18. An electronic device comprising:
a rear case;
a back cover coupled to the rear case;
an input pen insertion section arranged along a side of the rear case;
an input pen configured to be mounted in and removed from the input pen insertion section;
at least one sealing member mounted on an outer surface of the input pen, and configured to primarily fix the input pen while sealing an inner portion of the case by being at least partially in close contact with an inner surface of the case; and
a damper disposed in the input pen insertion section to secondarily fix the input pen inserted into the input pen insertion section.
